(19) United States
(12) Patent Application Publication
(10) Pub. No.: US 2006/0114855 A1
(43) Pub. Date: Jun. 1, 2006

(54) Quality of service (QOS) signaling for a wireless network

(76) Inventor: Haihong Zheng, Coppell, TX (US)

Correspondence Address: DITTHAVONG & CARLSON, P.C., Suite A, 10507 Braddock Road, Fairfax, VA, 22032, US

(21) Appl. No.: 11/290,305

(22) Filed: Nov. 30, 2005

Related U.S. Application Data
(60) Provisional application No. 60/631,924, filed on Nov. 30, 2004.

(51) Int. Cl. H04Q 7/00

(52) U.S. Cl. 370/331; 370/395.2

(57) ABSTRACT

An approach is provided for supporting Quality of Service (QoS) signaling between radio networks. A request message is generated for configuring an air link of a first radio network according to a Quality of Service (QoS) requirement specified in the request message, wherein the request message is transmitted to first radio network. Communication with the first radio network is established to negotiate admission control according to the request message, wherein the first radio network assigns a traffic identifier for a traffic flow to be carried over the air link of the first radio network and an airlink of a second radio network based on the QoS requirement.

### RELATED APPLICATIONS

This application claims the benefit of the earlier filing date under 35 U.S.C. §119(e) of U.S. Provisional Application Ser. No. 60/631,924 filed Nov. 30, 2004, entitled “Quality of Service (QoS) Signaling For A Wireless Network,” the entirety of which is incorporated by reference.

### FIELD OF THE INVENTION

The present invention relates to communications, and more particularly, to Quality of Service (QOS) signaling.

### BACKGROUND OF THE INVENTION

Radio communication systems, such as cellular systems and wireless local area networks (WLANs), provide users with the convenience of mobility. This convenience has spawned significant adoption by consumers as an accepted mode of communication for business and personal uses. Cellular service providers, for example, have fueled this acceptance by developing more enhanced network services and applications. In parallel, the prevalence of WLAN wireless technologies offers the possibility of achieving anywhere, any time connectivity to networking resources, such as Internet access. WLAN technology offers the advantage of high data rates, but is constrained by distance. Conversely, cellular systems support greater coverage, but are relatively limited in data rate. Consequently, the interworking of both cellular and WLAN technologies have received significant attention.

Because radio communication systems carry a wide range of traffic and a multitude of users, Quality of Service (QoS) considerations are important. The development of cellular and WLAN systems has largely been independent and driven by differing engineering and business challenges. Not surprisingly, QoS signaling, in the context of interworking across disparate radio communication systems, has not been adequately addressed by the industry.

Therefore, there is a need for an approach for QoS signaling across many communication systems.

### SUMMARY OF THE INVENTION

These and other needs are addressed by the present invention, in which an approach is presented for supporting Quality of Service (QoS) signaling between a wireless data network and a cellular system.

According to one aspect of an embodiment of the present invention, a method comprises generating a request message for configuring an air link of a first radio network according to a Quality of Service (QoS) requirement specified in the request message, wherein the request message is transmitted to first radio network. The method also comprises communicating with the first radio network to negotiate admission control according to the request message, wherein the first radio network assigns a traffic identifier for a traffic flow to be carried over the air link of the first radio network and an airlink of a second radio network based on the QoS requirement.

According to another aspect of an embodiment of the present invention, an apparatus comprises a processor configured to generate a request message for configuring an air link of a first radio network according to a Quality of Service (QoS) requirement specified in the request message, wherein the request message is transmitted to first radio network. The method also comprises a communication interface coupled to the processor and configured to communicate with the first radio network to negotiate admission control according to the request message, wherein the first radio network assigns a traffic identifier for a traffic flow to be carried over the air link of the first radio network and an airlink of a second radio network based on the QoS requirement.

According to another aspect of an embodiment of the present invention, a method comprises generating a request message for configuring an air link of a first radio network according to a Quality of Service (QoS) requirement specified in the request message, wherein the request message is transmitted to first radio network. The method also comprises communicating with the first radio network to negotiate admission control according to the request message, wherein the first radio network assigns a traffic identifier for a traffic flow to be carried over the air link of the first radio network and an airlink of a second radio network based on the QoS requirement.

According to another aspect of an embodiment of the present invention, an apparatus comprises a processor configured to generate a request message for configuring an air link of a first radio network according to a Quality of Service (QoS) requirement specified in the request message, wherein the request message is transmitted to first radio network. The apparatus also comprises a communication interface coupled to the processor and configured to communicate with the first radio network to negotiate admission control according to the request message, wherein the first radio network assigns a traffic identifier for a traffic flow to be carried over the air link of the first radio network and an airlink of a second radio network based on the QoS requirement.

According to another aspect of an embodiment of the present invention, a method comprises receiving an add stream request message from a mobile station to configure an air link of a wireless local area network, wherein the add stream request message includes a Quality of Service (QoS) parameter and a traffic identifier, the traffic identifier corresponding to a traffic flow to be carried over the air link of the wireless local area network and an airlink of a cellular network. The method also comprises performing admission control and QoS authorization with the mobile station based on the QoS parameter. Further, the method comprises generating an add stream response message to acknowledge the received request message.

According to yet another aspect of an embodiment of the present invention, a system comprises means for receiving an add stream request message from a mobile station to configure an air link of a wireless local area network, wherein the add stream request message includes a Quality of Service (QoS) parameter and a traffic identifier, the traffic identifier corresponding to a traffic flow to be carried over the air link of the wireless local area network and an airlink of a cellular network. The system also comprises means for performing admission control and QoS authorization with the mobile station based on the QoS parameter. Further, the system comprises means for generating an add stream response message to acknowledge the received request message.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawings and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of the architecture of a wireless system capable of supporting a Quality of Service (QoS) signaling scheme, in accordance with an embodiment of the present invention;

FIG. 2 is a ladder diagram of a QoS signaling process within a spread spectrum system;

FIG. 3 is a diagram showing a successful stream creation signaling process in a WLAN;

FIG. 4 is a diagram of the QoS signaling schemes for interworking between radio communication systems, in accordance with various embodiments of the present invention;

FIGS. 5A and 5B are ladder diagrams of a QoS signaling scheme based on a spread spectrum system, according to an embodiment of the present invention;

FIG. 6 is a ladder diagram of a WLAN link level QoS signaling process, according to an embodiment of the present invention;

FIG. 7 is a ladder diagram of a Layer 3 (L3) QoS signaling process, according to an embodiment of the present invention;

FIG. 8 is a diagram of a dual mode mobile station capable of operating in the system of FIG. 1, according to an embodiment of the present invention;

FIG. 9 is a diagram of hardware that can be used to implement an embodiment of the present invention.

FIGS. 10A and 10B are diagrams of different cellular mobile phone systems capable of supporting various embodiments of the invention;

FIG. 11 is a diagram of exemplary components of a mobile station capable of operating in the systems of FIGS. 10A and 10B, according to an embodiment of the invention; and

FIG. 12 is a diagram of an enterprise network capable of supporting the processes described herein, according to an embodiment of the invention.

### DESCRIPTION OF THE PREFERRED EMBODIMENT

An apparatus, method, and software for providing Quality of Service (QoS) signaling are described. In the following description, for the purposes of explanation, numerous specific details are set forth in order to provide a thorough understanding of the present invention. It is apparent, however, to one skilled in the art that the invention may be practiced without these specific details or with an equivalent arrangement. In other instances, well-known structures and devices are shown in block diagram form in order to avoid unnecessarily obscuring the present invention.

Although the various embodiments of the invention are described with respect to a wireless local area network and a spread spectrum cellular network, it is recognized and contemplated that the invention has applicability to other radio networks.

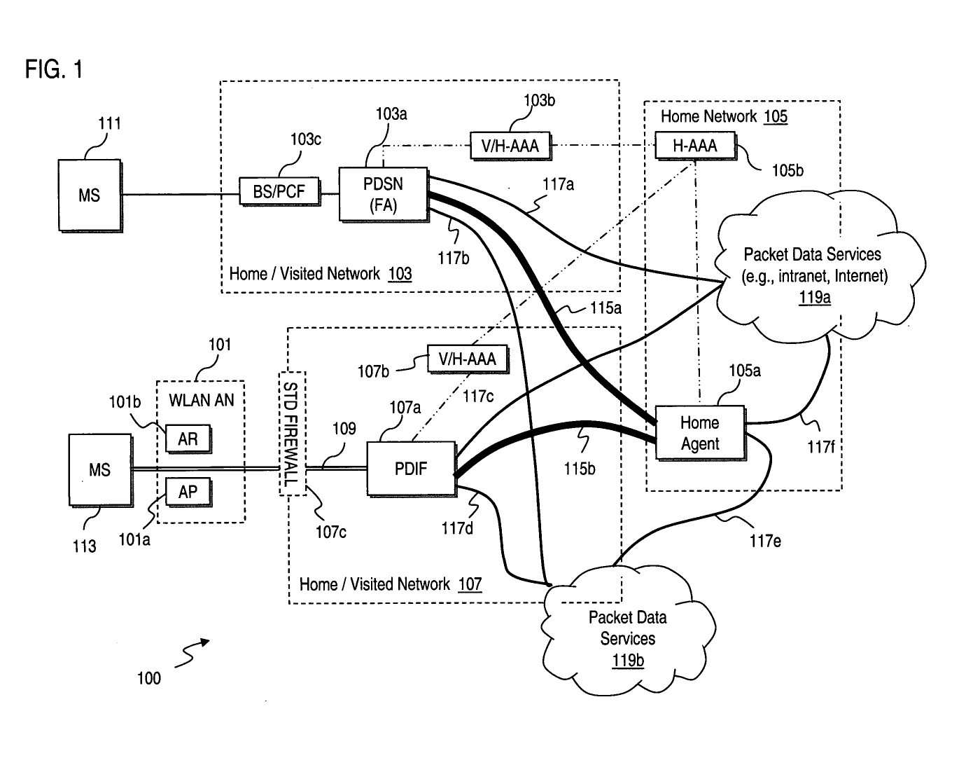

FIG. 1 is a diagram of the architecture of a wireless system capable of supporting a Quality of Service (QoS) signaling schemes, in accordance with various embodiments of the present invention. A wireless system 100 has an Interworking (IW) architecture that provides QoS signaling between a wireless local area network (WLAN) and a spread spectrum system comprised of networks 103, 105 and 107. For the purposes of explanation, the spread spectrum system has a cdma2000 architecture for supporting transport of packets.

The network 103 includes a Packet Data Serving Node (PDSN) 103a and an Authentication, Authorization, and Accounting (AAA) system 103b. The PDSN 103a aggregates data traffic from one or more Radio Network Controllers (RNCs) (not shown) and interfaces a Radio Access Network (RAN) (not shown) to a packet switched network. The PDSN 103a terminates a Point-to-Point (PPP) connection and maintains session state for each mobile station (MS) 111 (only one of which is shown) in its serving area. The mobile station (also denoted as mobile node or device) can be any variety of user equipment terminal—e.g., a mobile telephone, a personal digital assistant (PDA) with transceiver capability, or a personal computer with transceiver capability.

The radio network 107 includes a Packet Data Interworking Function (PDIF) entity 107a, which can interface with a Third Generation Partnership Project 2 (3GPP2) AAA infrastructure. The PDIF 107a may be located either in the home network or in a visited network. If the PDIF 107a is located in the home network then the PDIF 107a may be co-located with the Home Agent (HA) 105a. If the PDIF 107a is located in a visited network, this arrangement allows the WLAN user access to packet data services provided by the visited network 107.

The Packet Data Interworking Function (PDIF) entity 107a interfaces the WLAN access node (AN) 101 through a standard firewall 107c to the MS 113. The PDIF 107a, among other functions, serves as a security gateway between the Internet (not shown) and the packet data services; the PDIF 107a resides in the serving cdma2000 network (which may be a home network or a visited network). In addition, the PDIF 107a provides end-to-end secure tunnel management procedures between itself and the MS 113; these procedures include establishment and release of the tunnel, allocation of an network address (e.g., Internet Protocol (IP) address) to the MS 113, and traffic encapsulation and de-capsulation to and from the MS 113. Further, the PDIF 107a implements security policies (e.g., packet filtering and routing) of the network operator. In conjunction with the V/H (Visited/Home)-AAA 107b, the PDIF 107a supports user authentication and transfer of authorization policy information. The PDIF 107a also collects and transmits per-tunnel accounting information. The PDIF 107a is further detailed in described 3GPP2 X.S0028-200, entitled “Access to Operator Services and Mobility for WLAN Interworking” (which is incorporated herein by reference in its entirety).

The WLAN AN 101 includes an Access Point (AP) 101a for providing connectivity to the MS 113 as well as a router 101b that is configured to provide QoS capabilities (i.e., flow classification, marking, etc.). The networks 103 and 107 can be either a home or visited network. The home network 105 includes a home agent 105a and an AAA system 105b.

According to an exemplary embodiment, the interworking architecture of the system 100, among other capabilities, provides a secure end-to-end (e.g., Virtual Private Network (VPN)) tunnel 109 between the MS 113 and the PDIF 107a, which is a tunnel end-point. In the example of FIG. 1, the MS 111 connects to the PDSN 103a over, for example, a Point-to-Point Protocol (PPP) session. The PDSN 103a maintains a mobile IP tunnel 115a to the home agent 105a, which in turn carries a mobile IP tunnel 115b to the PDIF 107a. As shown, links 117a-117f within the system 100 include IP sessions (e.g., supporting mobile IPv6 Route Optimization (RO) operation) to communicate among the packet data services 119a, 119b, the PDSN 103a, the PDIF 107a, and the home agent 105a. Mobile IP permits a MS to communicate with a peer despite movement by the MS and changes in IP addresses. The RO mode of operation enables the use of a better (e.g., shorter) route to be used to reach the peer even though this better route is not through a home agent.

The concept behind mobile IP is to permit the home agent 105a to function as a stationary proxy for a mobile node (MN) (e.g., MS 111, 113). When the MS 111, for example, moves away from the home network, the home agent 105a intercepts packets destined for the home address (HoA) of the MS 111 and forwards the packets over a mobile IP tunnel to the current address of the MS 111—i.e., care-of-address (CoA). In this way, the transport layer sessions (e.g., Transmission Control Protocol (TCP) and User Datagram Protocol (UDP)) can use the HoA as a stationary identifier. Hence, tunnels are established through the home agent 105a, which can negatively impact network performance. To minimize the performance degradation, route optimization is utilized, whereby the mobile node sends the current CoA to a correspondent node using binding update messages.

The Packet Data Interworking Function (PDIF) 107a, in an exemplary embodiment, can interface with a Third Generation Partnership Project 2 (3GPP2) AAA infrastructure. The PDIF 107a may be located either in the home network or in a visited network. If the PDIF 107a is located in the home network then the PDIF 107a may be co-located with the Home Agent (HA). If the PDIF 107a is located in a visited network, this arrangement allows the Wireless Local Area Network (WLAN) user access to packet data services provided by the visited network 107.

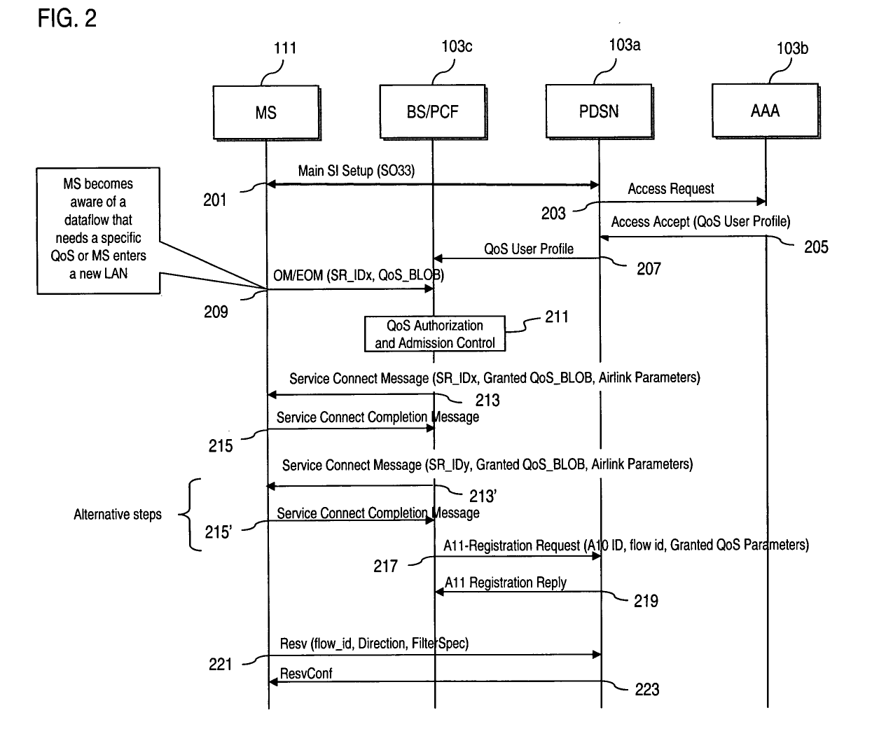

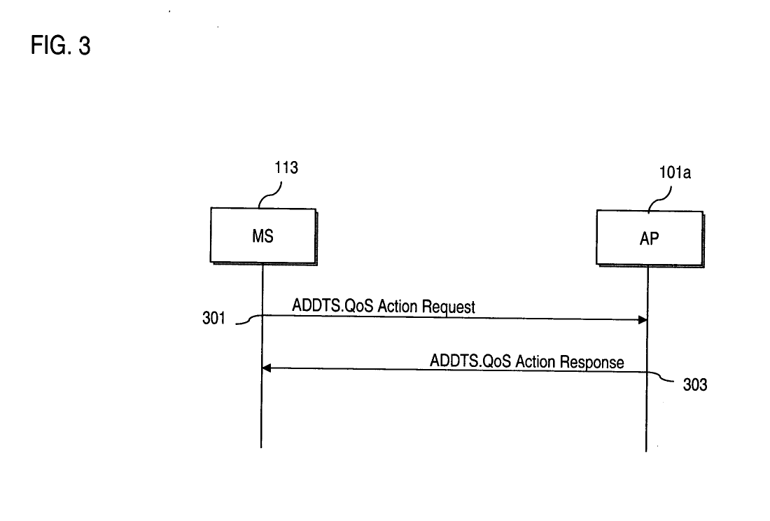

It is recognized that one of the design principles for the QoS signaling model, according to various embodiments, is to isolate modifications to the upper layers (e.g., QoS signaling module) that can be shared by both cdma2000 and WLAN modes at the lowest level, and to keep the modification to the current WLAN QoS scheme at the lowest level. Before describing the details of the QoS signaling model for the IW system 100, it is instructive to examine the QoS signaling scheme for a cdma2000 system and a WLAN system, as shown in FIGS. 2 and 3, respectively.

Although the QoS signaling model, according to various exemplary embodiments, are discussed in the context of a wireless network environment involving spread spectrum systems and IEEE 802.11, the approach can be applied to other environments, such as GSM (Global System for Mobile Communications), UMTS (Universal Mobile Telecommunications Service) and WiMax.

FIG. 2 is a ladder diagram of a QoS signaling process within a spread spectrum system. In step 201, the Main SI is established between the MS 111 and the PDSN 103a. The PDSN 103a then sends an Access Request to the AAA 103b, per step 203. In turn, the AAA 103b responds with an Access Accept message, which includes a QoS user profile (step 205). The PDSN 103a forwards, as in step 207, the QoS user profile to the Base Station/Packet Control Function (BS/PCF) 103c.

At this point, the MS 111 becomes aware of the dataflow that needs a specific QoS, or the MS 111 enters a new LAN. In step 209, the MS 111 sends an Origination Message/Enhanced Origination (OM/EOM) to the BS/PCF 103c. This message includes an air interface service instance (SR_IDx) and a QoS_BLOB (Block of Bits), which specifies the flow based QoS requirements as well as the unique FlowId(s) (i.e., flow identifiers) created by the MS 111 for the respective flows. For instance, during or after the service negotiation between the MS 111 and an application server (not shown) using application level signaling (e.g., Session Initiation Protocol (SIP)), the MS 111 derives the allowed service level QoS parameters from, e.g., a Session Description Protocol (SDP) message and maps them to the cdma2000 link level QoS parameters, which are contained in the QoS_BLOB. If the current air link configuration cannot satisfy the required QoS, the MS 111 requests the BS/PCF 103c to establish a new or modify the current air link configuration based on the QoS parameters defined in the QoS_BLOB. As noted, in addition to the QoS parameter, QoS_BLOB also contains the FlowId attribute which uniquely identifies an individual flow coming from/to the MS 111.

In step 211, the BS/PCF 103c performs authorization and admission control in response to the request by the MS 111 to activate the flows; this is successful if the BS/PCF 103c determines that the air interface can support the flows. Thereafter, the BS/PCF 103c sends a Service Connect Message to the MS 111 to setup the new service instance, as in step 213. The Service Connect Message includes the new air interface service instance, SR_IDx, the granted QoS_BLOB, and the airlink parameters. The MS 111 acknowledges with a Service Connect Completion Message, per step 215.

Alternatively, instead of steps 213 and 215, steps 213′ and 215′ are executed. With step 213′, the BS/PCF 103c utilizes an existing service instance (SR_IDy), and reconfigures the parameters of the service instance by including the SR_ID and the granted QoS_BLOB. In step 215′, the MS 111 sends a Service Connect Completion Message.

After the radio link is configured, the BS/PCF 103c also requests establishment of a new R-P (Radio-Packet) connection to PDSN 103a, along with the granted link level QoS parameters. Accordingly, the BS/PCF 103c sends an A11-Requestion Request message to the PDSN 103a, per step 217. This request message includes an A10 ID (corresponding to a new A10 connection), FlowID, and the granted QoS parameters. The PDSN 103a respond with an A11 Registration Reply message, as in step 219. It is noted that the establishment of a new A10 connection is required when a new over the air service instance is needed. However, if an existing service instance is used, the A11 Registration Request message would include parameters for the existing connection.

The MS 111 then uses flow mapping messages (i.e., 3GPP2 Resv message) to inform PDSN 103a about the mapping between FlowId and traffic filter attributes (e.g., IP address, port number). The authorization token is included if applicable. In step 221, the MS 111 transmits a Resv message to the PSDN 103a to indicate the FlowID and the FilterSpec for the new flow; the message also can include the authorization token and corresponding FlowID. If the granted QoS parameters are acceptable (i.e., within the limits established by the authorized QoS parameters), the PDSN 103a confirms receipt of the Resv message by sending a Resv_Conf message.

The above process is detailed in 3GPP2 Interim Standard (IS) 835-D, which is incorporated herein by reference in its entirety; the IS 835-D defines a QoS signaling concept which can be applied to both 1× EV-DO (Evolutionary-Data and Voice) and 1× EV-DO (Evolutionary-Data Optimized) system. It is thus contemplated that the invention, according to various embodiments, has applicability to such systems.

It can be observed that in cdma2000 system, although the end-to-end Resource Reservation Protocol (RSVP) is not excluded from the QoS signaling, it only deals with QoS in the external network (i.e., the network beyond PDSN or border router). The QoS support in the cdma2000 network (including both Radio Access Network (RAN) and core network) is triggered by a link level QoS signaling (i.e., OM/EOM). To provide an interworking to network level QoS, certain Layer 3 (L3) information (e.g., FlowId) is carried in the link level signaling as well. L3, according to various embodiments, refers to a protocol providing signaling application to support, for example, L3 CDMA functions.

The link level QoS signaling scheme within a WLAN is described with respect to FIG. 3.

FIG. 3 is a diagram showing a successful stream creation signaling process in a WLAN. Similar to the cdma2000 MS, the MS 113 also has QoS specific signaling capabilities at the link level and is able to use QoS specific channel access parameter according to a command from an AP 101a. The MS 113 initiates a stream creation, and the AP 101a accepts or rejects the stream. The AP 101a can also modify the traffic stream parameters and accept a modified traffic stream.

More specifically, in a successful stream creation signaling procedure, the MS 113 sends an add stream request (ADDTS.QoS action request) to the AP 101a, per step 301. The ADDTS.QoS action request includes a Traffic Specification (TSPEC) information element that describes the characteristics of the traffic flow for both uplink and downlink. TSPEC is used for Enhanced Distributed Channel Access (EDCA) (for admission control) and HCCA (HFC (Hybrid Coordination Function) Controlled Channel Access) streams. The HCCA scheduling can use the complete information of the TSPEC, while EDCA needs information from a few fields of TSPEC. The QoS parameters of TSPEC include minimum data rate, peak data rate, delay bound, etc. Other fields in the TSPEC include a Traffic Identifier (TID) that is used to distinguish packets to Medium Access Control (MAC) entities with supported QoS.

By way of example, 16 possible TID values are provided: 8 identify standard traffic categories, and the other 8 (termed as TSID (Transport Stream Identifier)) identify parameterized traffic streams. Only the parameterized traffic stream is supported by TSPEC. TID is assigned by the layers above the WLAN MAC (Medium Access Control) layer. Within the current standard, it is not specified whether different flows with the same QoS requirement from the same MS should be assigned with the same TID. Two possible scenarios are considered. First, if the two flows have the same QoS requirement that can be specified by the 8 standard traffic categories, these two flows can be assigned with the same TID. Second, if the two flows have the same QoS requirement that can be only specified by parameterized TSPEC, these two flows can be assigned with the same or different TSID. The assignment is at the discretion of the layers above WLAN MAC.

In step 303, the AP 101a sends a QoS Action Response to the MS 113. Unlike FlowID used in cdma2000 network, TSID in WLAN cannot uniquely identify an IP flow. Therefore, the QoS signaling concept adopted in cdma2000 system cannot be directly applied in the cdma2000-WLAN IW system 100. Additionally, it is recognized that similar to cdma2000 networks, two levels/types of QoS signaling scheme can be applied to the cdma2000-WLAN IW system 100. To provide a single implementation of upper layer function in the cdma2000/WLAN dual mode phone, it has been suggested to use the similar scheme as that applied in the cdma2000 system. However, such an approach may introduce certain modification to the WLAN link layer protocol, which may not be feasible in the WLAN standardization.

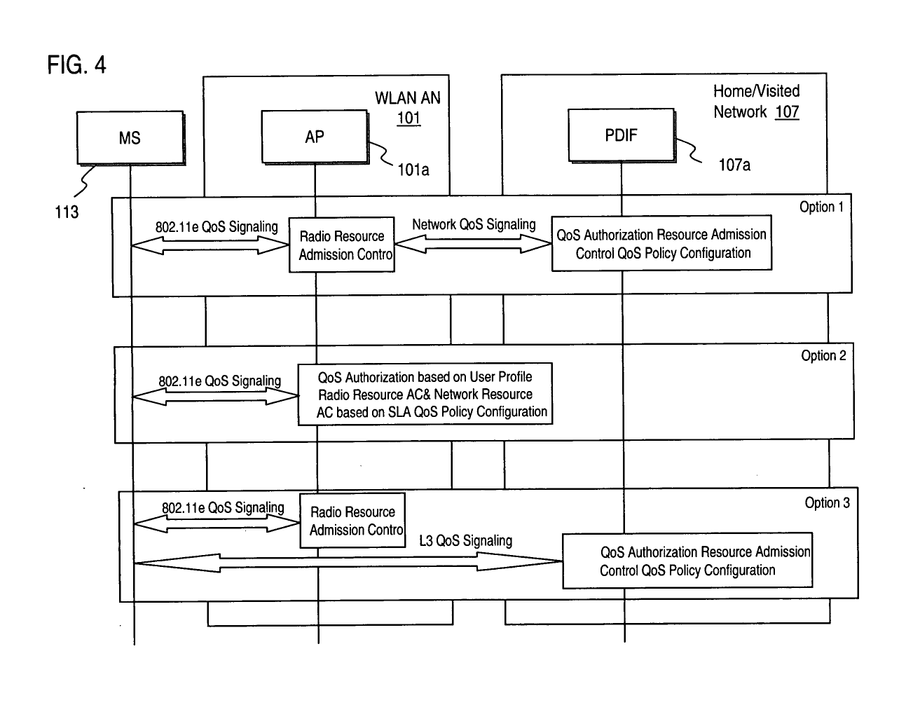

Accordingly, the invention, according to various embodiments (as shown in FIGS. 4-7), introduces a new QoS signaling scheme for interworking between wireless systems, such as cdma2000 and WLAN. The new QoS signaling model advantageously provides an efficient packet-based air interface without requiring any changes to the core network signaling and traffic processing systems—e.g., a packet control function (PCF), a packet data switched network (PDSN) and IP-based AAA servers.

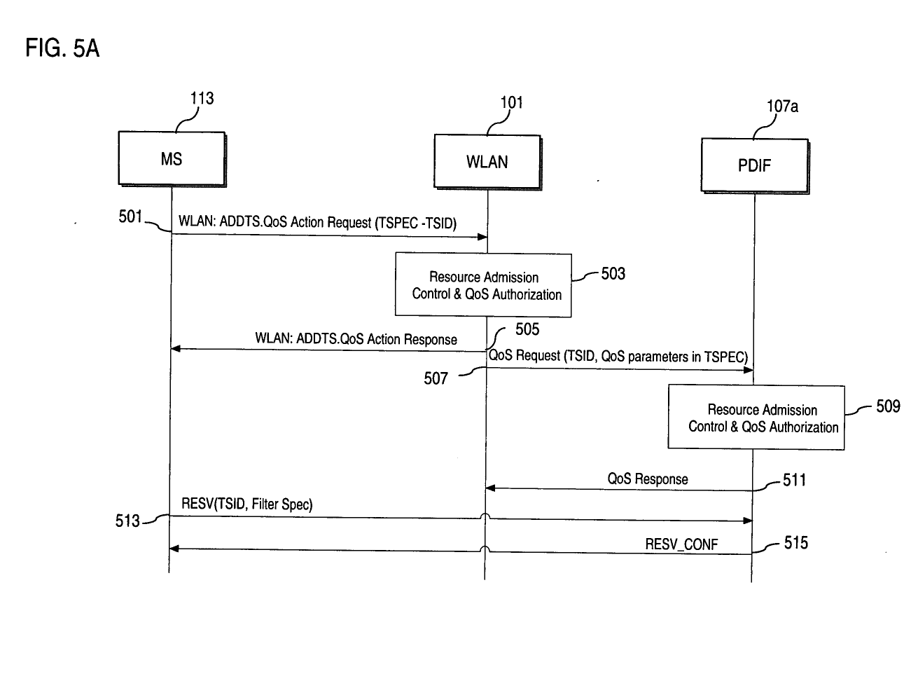

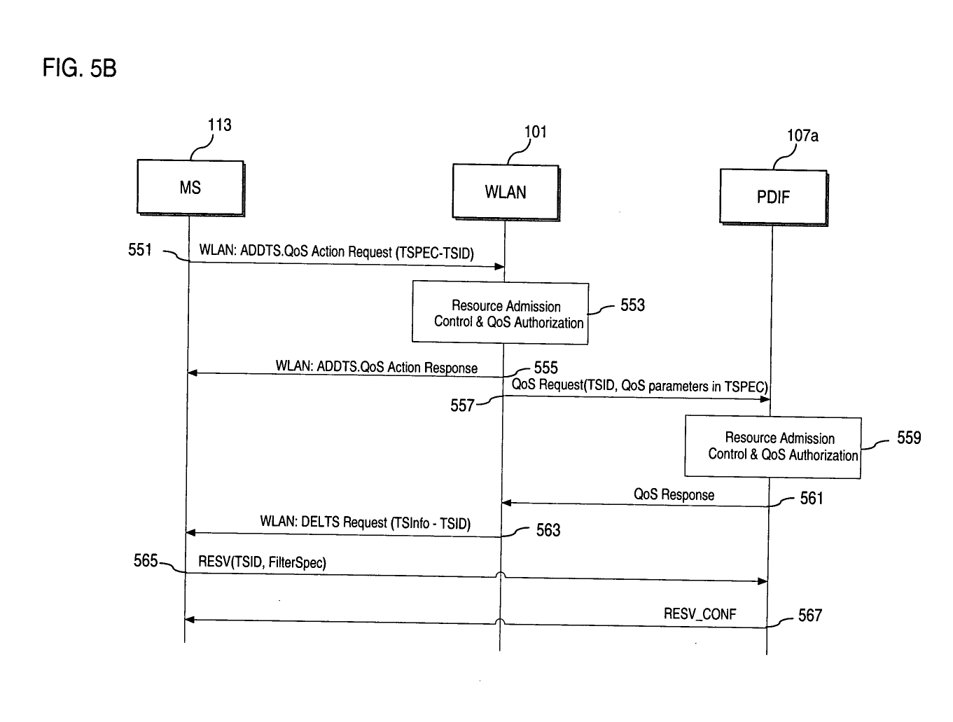

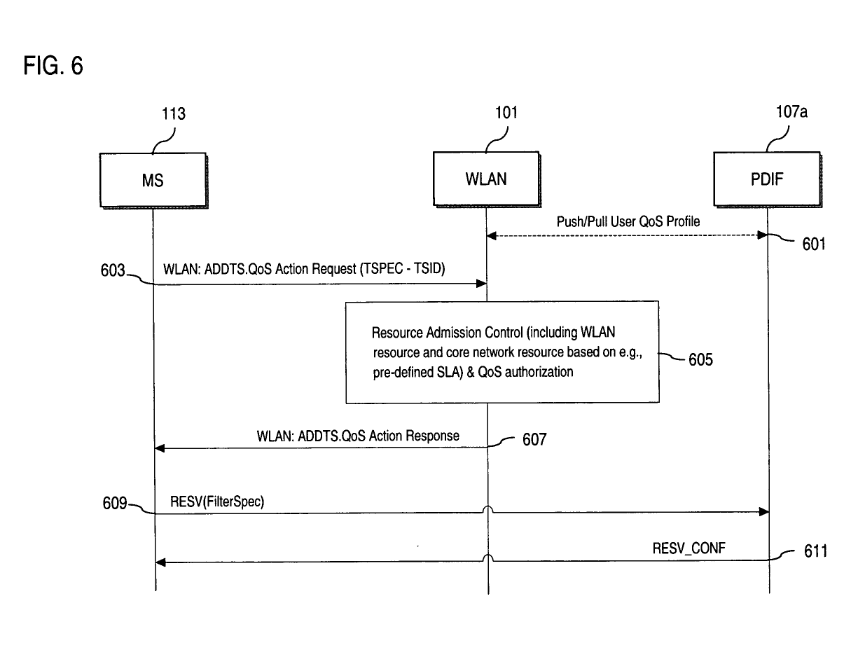

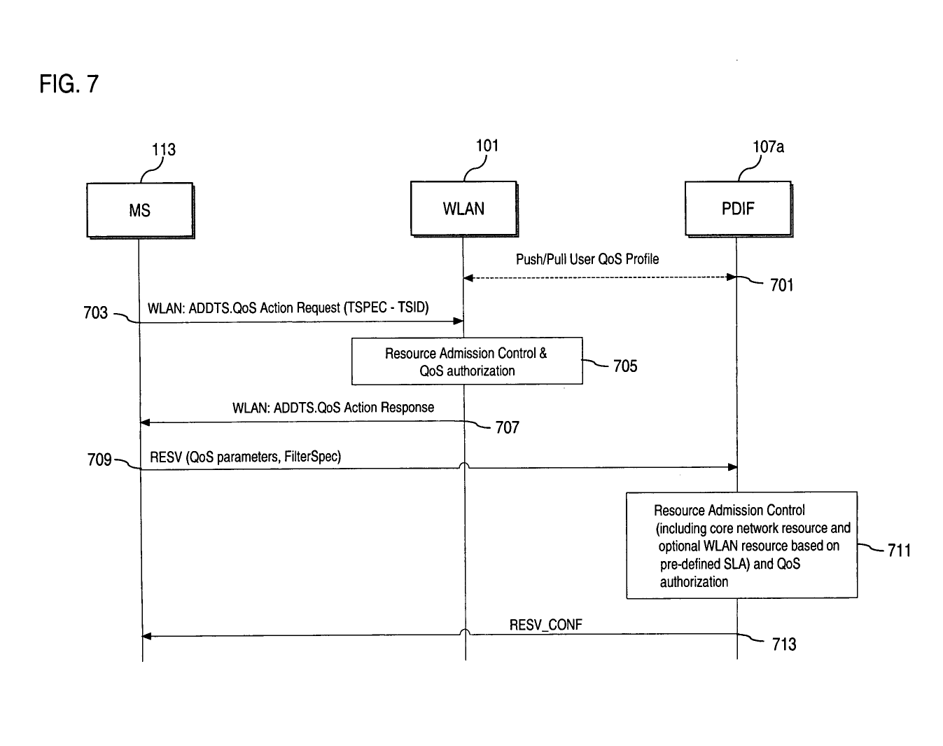

FIG. 4 is a diagram of the QoS signaling schemes for interworking between radio communication systems, in accordance with various embodiments of the present invention. According to various embodiments of the invention, three options of the QoS signaling scheme can be applied for supporting QoS provisioning of the IW system 100 (shown in FIG. 1). Option 1 provides a cdma2000-like approach, wherein the WLAN AN 101 communicates QoS requirements at the network level with the PDIF 107a. This option is further detailed in FIGS. 5A and 5B. Option 2 is a WLAN Link Level QoS Signaling approach. Under this option, the WLAN AN 101 performs resource admission control based on a pre-defined Service Level Agreement (SLA). Option 3 provides an Independent Link Level Signaling and L3 QoS Signaling; this option involves the MS 113 communicating the QoS requirements to the PDIF 107a using L3 signaling. The details of Option 2 and Option 3 are explained in FIGS. 6 and 7, respectively.

Admission control procedures involve a negotiation with the MS 113, which captures QoS requirements of the media streams and maps such requirements to a MAC layer TSPEC description. As noted earlier a TSPEC element provides traffic flow characteristics for the uplink and the downlink. The TSPEC element includes the source address (MAC), destination address, TSID, and QoS parameters of the media stream. If the WLAN 101, for instance, can accommodate the QoS requirements of the MS 113, the admission control procedures result in successful admission of the media stream of the MS 113. The stream is registered with a network device (e.g., edge router) that can discern and process the different flows according to the QoS requirements.

FIGS. 5A and 5B are ladder diagrams of a QoS signaling scheme based on a spread spectrum system, according to an embodiment of the present invention. In particular, as shown in FIG. 5A, the signaling scheme in a successful case is as follows. The MS 113, per step 501, sends an ADDTS.QoS Action Request to the WLAN 101; the request includes the TSID along with the detailed QoS parameters. It may be required that the TSID field uniquely identify a single flow. In step 503, the WLAN 101 performs WLAN resource admission control and local policy based QoS authorization upon receiving the request. The WLAN 101 then responds with ADDTS.QoS Action Response, as in step 505, to acknowledge the received request.

After receiving and authorizing link level QoS signaling over the WLAN 101 air interface, the WLAN 101 sends a L3 QoS request to the PDIF 107a (step 507). The QoS request contains the granted QoS parameters that are carried in the TSPEC, and the TSID for the forward link traffic. Such QoS parameters are used by the PDIF 107a to perform QoS authorization (per step 509) (based on user profile and network local policy), resource admission control and traffic policing/shaping in the cdma2000 core network. In step 511, the PDIF 107a then sends the response back to the WLAN 101.

Next, the MS 113 sends flow mapping message Resv with the TSID and authorization token if applicable for the forward link traffic to the PDIF 107a, as in step 513. The TSID and FilterSpec carried in the Resv message enable the PDIF 107a to map the forward link data traffic to the correct TSID. In addition, to aid the WLAN 101 in identifying the TSID assigned to the downlink flow, the tunneling header in the packet from the PDIF 107a to the MS 113 (for Option 1 architecture) or from PDIF 107a to the WLAN 101 (for Option 2 architecture) includes the TSID for the packet, or the tunneling establishment protocol specify a one-to-one mapping between TSID to a tunnel identifier (for Option 2 architecture only).

It is noted that the TSID in steps 507, 513 and 515, respectively, are optional. Similar to the function of the FlowId in a cdma2000 system, the TSID in the steps above is used to help the WLAN 101 to identify the forward link traffic characteristics in the WLAN 101 and then to map to an appropriate TSID. If the WLAN 101 has other mechanisms to identify the traffic type and assign the TSID appropriately, there is no need to signal TSID in the steps above. For example, the optional Traffic Classification information element carried in the ADDTS.QoS Action Request carries similar information, such as FilterSpec, which can be used by the WLAN 101 to map the forward link traffic to the correct TSID.

The TSID and FilterSpec, as specified in the Resv message, are used by PDIF 107a to identify the forward link traffic flow, while the QoS information in step 507 are used by PDIF 107a to perform traffic policing and shaping in addition to authorization and admission control. Furthermore, if Diffserv is supported over WLAN 101 and PDIF 107a, the information above can also be used by the PDIF 107a to determine the DSCP (Differentiated Services Code Point), which is to be assigned for each flow identified by the unique TSID. The Diffserv marking policy for the forward link traffic is maintained in the PDIF 107a, while the marking policy for the reverse link traffic can be optionally pushed to the WLAN 101 in the QoS response message of step 511.

FIG. 5B shows a QoS signaling procedure, involving a failure scenario. Steps 551-561 resembles steps 501-507, respectively. Upon failure of the admission control or authorization process (step 509), the QoS response transmitted by the PDIF 107a (per step 511) accordingly indicates that a failure has occurred. Consequently, the WLAN 101 deletes the created stream over the WLAN interface through issuance of a DELTS (Delete Stream) Request message, which includes the TSinfo and TSID (step 563). In step 565, the MS 113 generates a Resv message, which specifies the TSID and FilterSpec parameters; this message is then forwarded to the PDIF 107a. In response, the PDIF 107a replies with a Resv_Conf message.

The above described process provides a number of advantages. The signaling model in the WLAN 101 is similar to that in the cdma2000 system, thereby enabling a similar implementation of the upper layers in the MS 113. Another advantage is that the per-flow based QoS authorization and admission control is enabled in the cdma2000 core network. In addition, since the QoS authorization based on user profile can be enforced in the cdma2000 core network, there is no need to push the user profile to the WLAN 101. Also, the consistency of requested/admitted QoS over the WLAN radio interface and in the cdma2000 core network is provided by the WLAN 101 instead of the MS 113. Further, only minor modifications to the cdma2000 flow mapping mechanism is required.

With the QoS signaling of FIGS. 5A and 5B, it may be necessary to guarantee the uniqueness of the TSID among multiple flows. As a result, a limited number of flows (e.g., 8) can be supported simultaneously for the MS 113.

Additionally, a new interface is introduced between WLAN 101 and PDIF 107a for the following functions. First, the QoS signaling, as in steps 507 and 509, is over this interface. If WLAN 101 does not have the capability to map the forward link traffic to the appropriate TSID, the TSID information should be transmitted from the PDIF 107a to the WLAN 101 in the tunneling header (as applied to both architecture Option 1 and Option 2); alternatively, the tunneling setup protocol should carry one-to-one mapping between the TSID and the tunnel identifier (applied to only Option 2).

FIG. 6 is a ladder diagram of a WLAN link level QoS signaling process, according to an embodiment of the present invention. This example represents the Option 2 architecture, which operates as follows. Under this scenario, the WLAN 101 and PDIF 107a obtain the user QoS profile utilizing a push or pull mechanism, as in step 601. The MS 113 signals, as in step 603, a WLAN QoS request, for example, according to a standard WLAN procedure. It is noted that the uniqueness of TSID among multiple flows is not needed.

The WLAN QoS request triggers the WLAN 101 to perform, per step 603, resource admission control in both the WLAN 101 and the core network. The resource admission control for the core network is based, in an exemplary embodiment, on a pre-defined Service Legal Agreement (SLA) between the WLAN 101 and the cdma2000 core network where the PDIF 107a is located. Alternatively, inter-network QoS signaling protocol (e.g., inter bandwidth broker communication protocol) is utilized to support the resource admission control. QoS authorization is based on the WLAN local policy. However, if the user profile is pushed into the WLAN 101 from the cdma2000 core network during user registration period, the user based QoS authorization is performed as well. It is observed that no TSID or associated QoS parameter for each flow are needed to be sent to the PDIF 107a. The WLAN 101 may also perform user-based QoS authorization if the QoS profile is pushed from cdma2000 network to the WLAN 101 during the user registration period.

Subsequently, the WLAN 101 sends a ADDTS.QoS Action Response to the MS 113, per step 607. The WLAN 101, in one embodiment, may need to map the forward link traffic to the appropriate TSID (e.g., using the Traffic Classification IE in the ADDTS.QoS Action Request). In steps 609 and 611, the MS 113 transmits a Resv message to the PDIF 107a, which responds with a Resv_Conf message. In accordance with an embodiment of the invention, the flow mapping message Resv follows the same format as defined in cdma2000 network; however, the FlowId is not used by the PDIF 107a to map to a particular flow. The WLAN 101, according to one embodiment, may be required to map the forward link traffic to the appropriate TSID (e.g., using the Traffic Classification IE in the ADDTS.QoS Action Request). It is noted that the consistency of requested/admitted QoS over the WLAN radio interface and in the cdma2000 core network is provided by the MS 113 instead of the network.

The FilterSpec, specified in the Resv message, is used by the PDIF 107a to perform the gating function. It is noted that per-flow based admission control, authorization (except the gating function) and traffic policing/shaping are typically not allowed in the cdma2000 network. The authorization token is included in the Resv if applicable. The user based QoS authorization is not enabled unless the user QoS profile is pushed into WLAN 101 during user registration period. However, a service provider may be concerned with security if the user QoS profile is pushed into the WLAN 101 (which may not belong to the service provider).

The WLAN link level QoS signaling model has a number of advantages. No new interface is required between WLAN 101 and PDIF 107a. Additionally, one-to-one mapping between TSID and flow is not required. As long as the flows share the same QoS requirement, the same TSID can be assigned. Therefore, possibly more than 8 flows can be supported simultaneously in the system. Another advantage is that modification to the cdma2000 flow mapping mechanism is minor.

FIG. 7 is a ladder diagram of a L3 QoS signaling process, according to an embodiment of the present invention. For Option 3, the user QoS profile is either pushed or pulled between the WLAN 101 and PDIF 107a, per step 701 (as under Option 2). In step 703, the MS 113 signals its QoS request as defined in the standard WLAN 101 procedure. It is noted that there is no need to guarantee the uniqueness of TSID for multiple flows. The WLAN QoS request triggers WLAN 101 to perform resource admission control only in the WLAN 101, wherein the QoS authorization based on WLAN local policy (step 705). If the user profile is pushed into the WLAN 101 from the cdma2000 core network during user registration period, the user based QoS authorization is performed as well. It is noted that the WLAN QoS signaling is not mandatory in this approach (in case 802.11e is not supported by the MS or the AP); consequently, the resource admission control in WLAN is not triggered by the 802.11e signaling.

The WLAN 101 responds to the request from the MS 113 with a WLAN ADDTS.QoS Action Response, as in step 707. In turn, the MS 113 sends a Resv message, which specifies the QoS parameters and FilterSpec (step 709). In step 711, the resource admission control and QoS authorization by the cdma2000 core network (PDIF 107a) are triggered by a modified flow mapping message Resv sent from the MS 113. In addition to the existing information element, the Resv message also include the same QoS parameter required at the WLAN level as well. Thereafter, the PDIF 107a sends, as in step 713, a Resv_Conf message to the MS 113. In this scenario, no mapping between TSID and FilterSpec is performed. The FilterSpec is used by the PDIF 107a to perform gating function. The QoS parameters are also used by the PDIF 107a to perform traffic policing and shaping.

The architecture of Option 3 is advantageous in that a new interface is not need between the WLAN 101 and the PDIF 107a. Also, this QoS signaling scheme has the advantage of not being constrained by the requirement of a one-to-one mapping between the TSID and the flow, thereby potentially permitting more than 8 flows to be supported simultaneously in the system. Further, per-flow based admission control, authorization and traffic policing/shaping are allowed in the cdma2000 core network. In addition, since QoS authorization based on user profile can be enforced in the cdma2000 core network, there is no need to push the user profile to the WLAN 101.

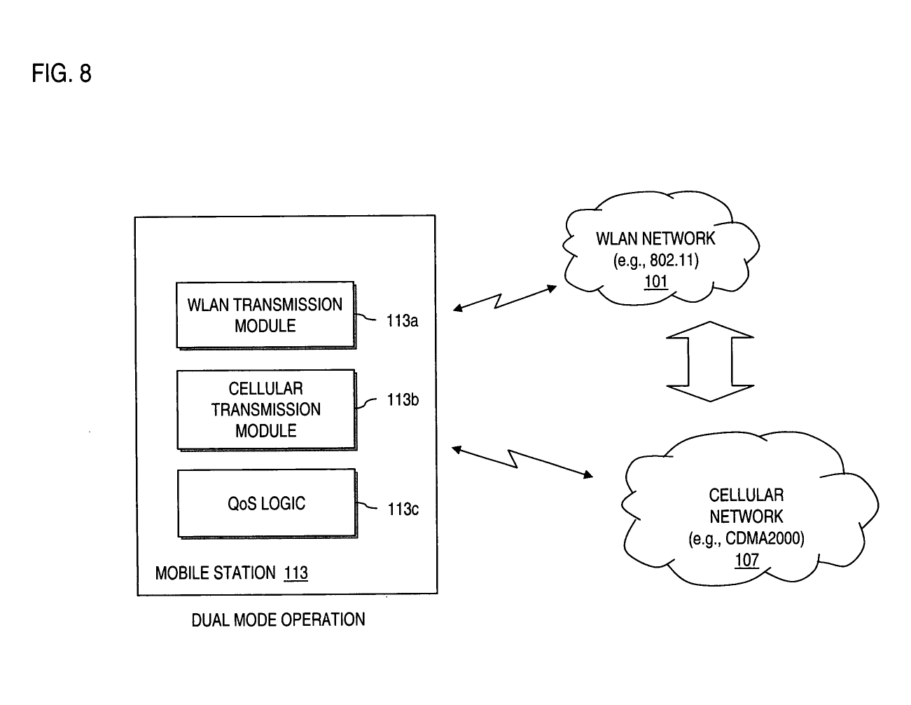

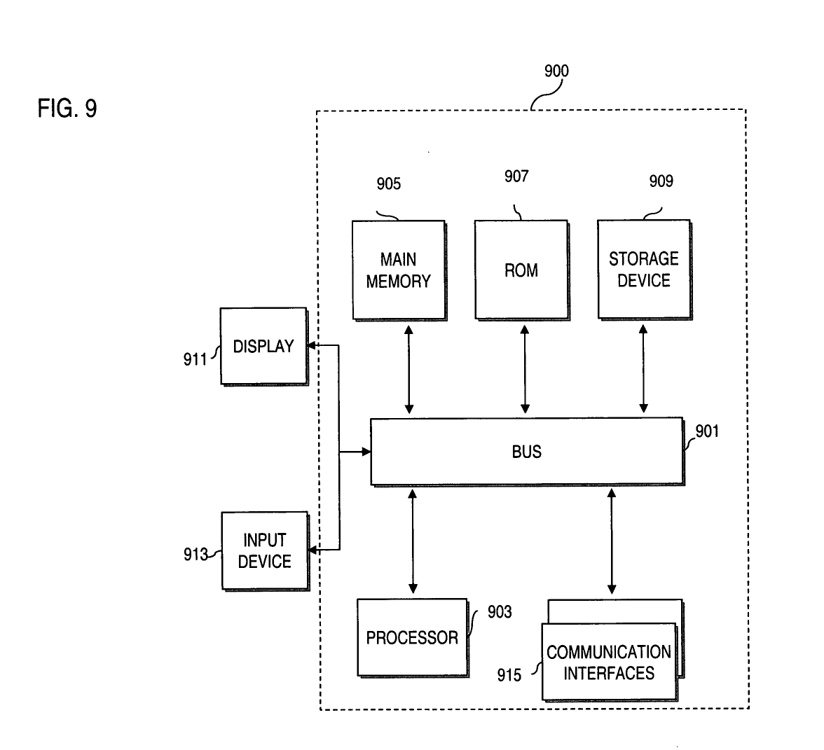

One of ordinary skill in the art would recognize that the processes for QoS signaling across multiple radio communication systems may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIGS. 8 and 9.

FIG. 8 is a diagram of a dual mode mobile station capable of operating in the system of FIG. 1, according to an embodiment of the present invention. It is contemplated that the MS 113, in an exemplary embodiment, can operate directly with the respective networks, WLAN 101 and cellular network 107. To support this dual mode configuration, the MS 113 includes a WLAN transmission module 113a for interfacing with the WLAN 101 and a cellular transmission module 113b for communicating over the cellular system 107. The MS 113 includes QoS logic 113c configured to support the architectural Options 1-3, as earlier described with respect to FIGS. 5-7.

FIG. 9 illustrates exemplary hardware upon which an embodiment according to the present invention can be implemented. A computing system 900 includes a bus 901 or other communication mechanism for communicating information and a processor 903 coupled to the bus 901 for processing information. The computing system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computing system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computing system 900 may be coupled via the bus 901 to a display 911, such as a liquid crystal display, or active matrix display, for displaying information to a user. An input device 913, such as a keyboard including alphanumeric and other keys, may be coupled to the bus 901 for communicating information and command selections to the processor 903. The input device 913 can include a cursor control, such as a mouse, a trackball, or cursor direction keys, for communicating direction information and command selections to the processor 903 and for controlling cursor movement on the display 911.

According to various embodiments of the invention, the processes of FIGS. 4-7 can be provided by the computing system 900 in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the present invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the present invention are not limited to any specific combination of hardware circuitry and software.

The computing system 900 also includes at least one communication interface 915 coupled to bus 901. The communication interface 915 provides a two-way data communication coupling to a network link (not shown). The communication interface 915 sends and receives electrical, electromagnetic, or optical signals that carry digital data streams representing various types of information. Further, the communication interface 915 can include peripheral interface devices, such as a Universal Serial Bus (USB) interface, a PCMCIA (Personal Computer Memory Card International Association) interface, etc.

The processor 903 may execute the transmitted code while being received and/or store the code in the storage device 909, or other non-volatile storage for later execution. In this manner, the computing system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

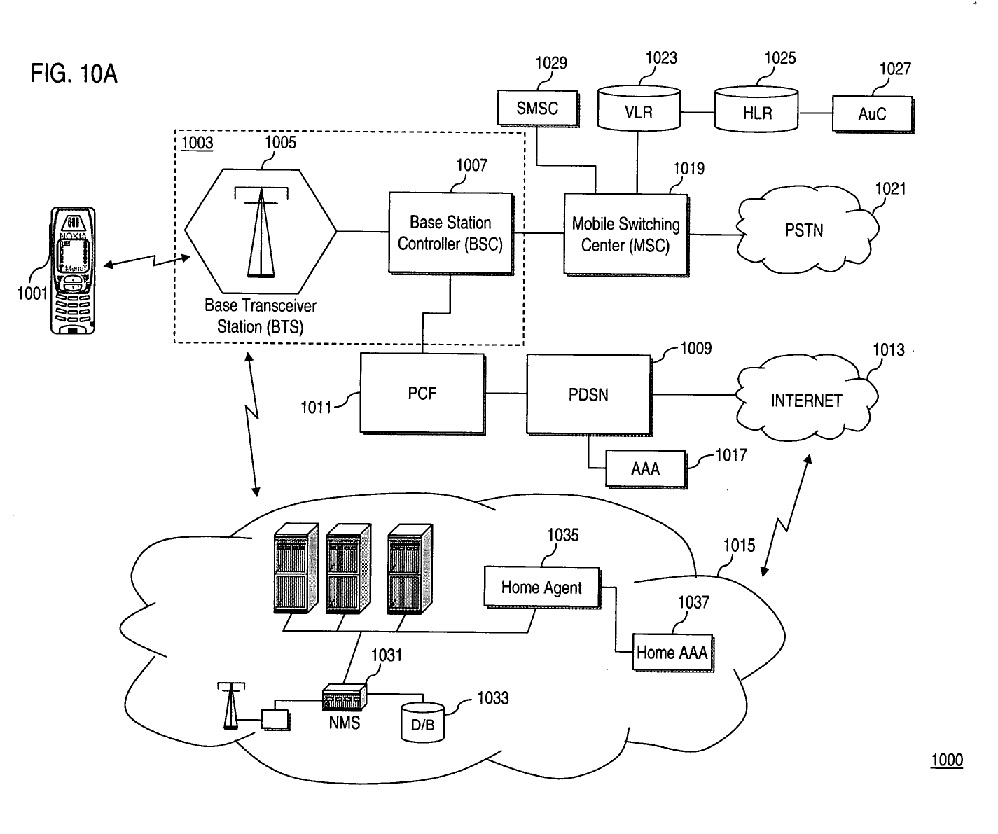

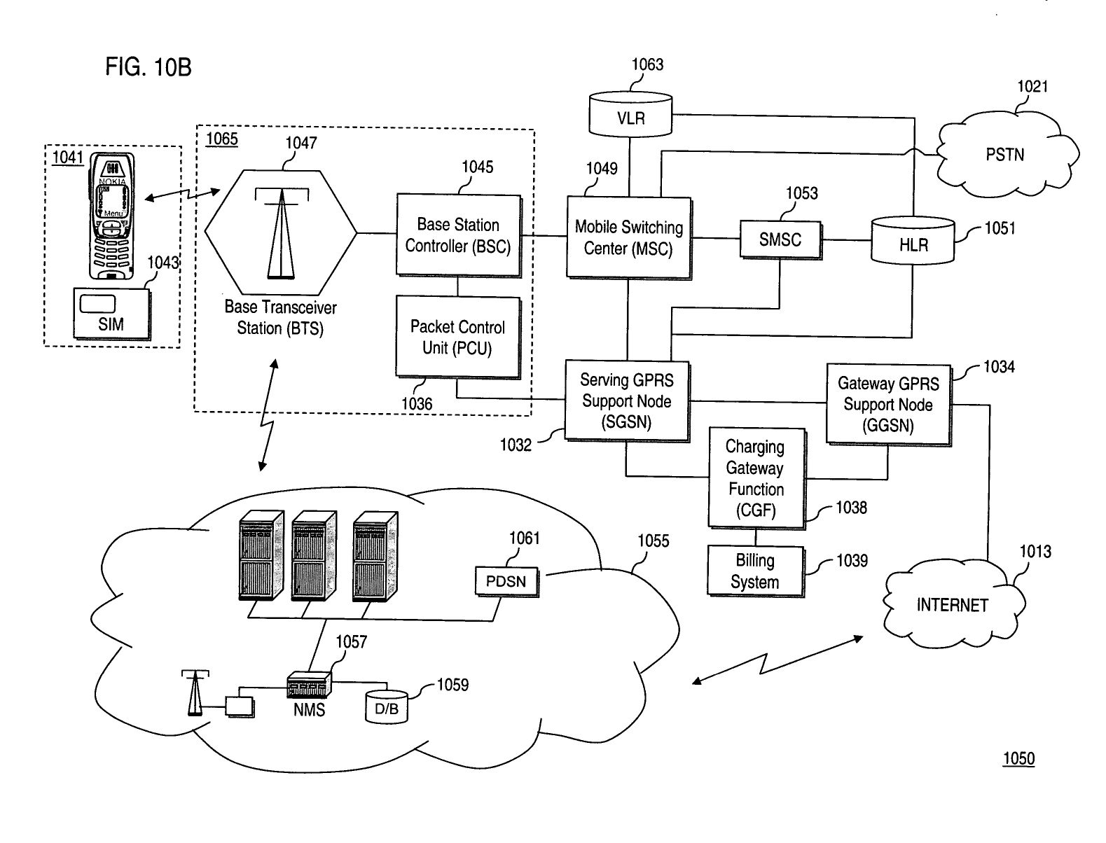

FIGS. 10A and 10B are diagrams of different cellular mobile phone systems capable of supporting various embodiments of the invention. FIGS. 10A and 10B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 1000 includes mobile stations 1001 (e.g., handsets, terminals, stations, units, devices, or any type of interface to the user (such as “wearable” circuitry, etc.)) in communication with a Base Station Subsystem (BSS) 1003. According to one embodiment of the invention, the radio network supports Third Generation (3G) services as defined by the International Telecommunications Union (ITU) for International Mobile Telecommunications 2000 (IMT-2000).

In this example, the BSS 1003 includes a Base Transceiver Station (BTS) 1005 and Base Station Controller (BSC) 1007. Although a single BTS is shown, it is recognized that multiple BTSs are typically connected to the BSC through, for example, point-to-point links. Each BSS 1003 is linked to a Packet Data Serving Node (PDSN) 1009 through a transmission control entity, or a Packet Control Function (PCF) 1011. Since the PDSN 1009 serves as a gateway to external networks, e.g., the Internet 1013 or other private consumer networks 1015, the PDSN 1009 can include an Access, Authorization and Accounting system (AAA) 1017 to securely determine the identity and privileges of a user and to track each user's activities. The network 1015 comprises a Network Management System (NMS) 1031 linked to one or more databases 1033 that are accessed through a Home Agent (HA) 1035 secured by a Home AAA 1037.

Although a single BSS 1003 is shown, it is recognized that multiple BSSs 1003 are typically connected to a Mobile Switching Center (MSC) 1019. The MSC 1019 provides connectivity to a circuit-switched telephone network, such as the Public Switched Telephone Network (PSTN) 1021. Similarly, it is also recognized that the MSC 1019 may be connected to other MSCs 1019 on the same network 1000 and/or to other radio networks. The MSC 1019 is generally collocated with a Visitor Location Register (VLR) 1023 database that holds temporary information about active subscribers to that MSC 1019. The data within the VLR 1023 database is to a large extent a copy of the Home Location Register (HLR) 1025 database, which stores detailed subscriber service subscription information. In some implementations, the HLR 1025 and VLR 1023 are the same physical database; however, the HLR 1025 can be located at a remote location accessed through, for example, a Signaling System Number 7 (SS7) network. An Authentication Center (AuC) 1027 containing subscriber-specific authentication data, such as a secret authentication key, is associated with the HLR 1025 for authenticating users. Furthermore, the MSC 1019 is connected to a Short Message Service Center (SMSC) 1029 that stores and forwards short messages to and from the radio network 1000.

During typical operation of the cellular telephone system, BTSs 1005 receive and demodulate sets of reverse-link signals from sets of mobile units 1001 conducting telephone calls or other communications. Each reverse-link signal received by a given BTS 1005 is processed within that station. The resulting data is forwarded to the BSC 1007. The BSC 1007 provides call resource allocation and mobility management functionality including the orchestration of soft handoffs between BTSs 1005. The BSC 1007 also routes the received data to the MSC 1019, which in turn provides additional routing and/or switching for interface with the PSTN 1021. The MSC 1019 is also responsible for call setup, call termination, management of inter-MSC handover and supplementary services, and collecting, charging and accounting information. Similarly, the radio network 1000 sends forward-link messages. The PSTN 1021 interfaces with the MSC 1019. The MSC 1019 additionally interfaces with the BSC 1007, which in turn communicates with the BTSs 1005, which modulate and transmit sets of forward-link signals to the sets of mobile units 1001.

As shown in FIG. 10B, the two key elements of the General Packet Radio Service (GPRS) infrastructure 1050 are the Serving GPRS Supporting Node (SGSN) 1032 and the Gateway GPRS Support Node (GGSN) 1034. In addition, the GPRS infrastructure includes a Packet Control Unit PCU (1036) and a Charging Gateway Function (CGF) 1038 linked to a Billing System 1039. A GPRS the Mobile Station (MS) 1041 employs a Subscriber Identity Module (SIM) 1043.

The PCU 1036 is a logical network element responsible for GPRS-related functions such as air interface access control, packet scheduling on the air interface, and packet assembly and re-assembly. Generally the PCU 1036 is physically integrated with the BSC 1045; however, it can be collocated with a BTS 1047 or a SGSN 1032. The SGSN 1032 provides equivalent functions as the MSC 1049 including mobility management, security, and access control functions but in the packet-switched domain. Furthermore, the SGSN 1032 has connectivity with the PCU 1036 through, for example, a Fame Relay-based interface using the BSS GPRS protocol (BSSGP). Although only one SGSN is shown, it is recognized that that multiple SGSNs 1031 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 1045, any given BSC 1045 generally interfaces with one SGSN 1032. Also, the SGSN 1032 is optionally connected with the HLR 1051 through an SS7-based interface using GPRS enhanced Mobile Application Part (MAP) or with the MSC 1049 through an SS7-based interface using Signaling Connection Control Part (SCCP). The SGSN/HLR interface allows the SGSN 1032 to provide location updates to the HLR 1051 and to retrieve GPRS-related subscription information within the SGSN service area. The SGSN/MSC interface enables coordination between circuit-switched services and packet data services such as paging a subscriber for a voice call. Finally, the SGSN 1032 interfaces with a SMSC 1053 to enable short messaging functionality over the network 1050.

The GGSN 1034 is the gateway to external packet data networks, such as the Internet 1013 or other private customer networks 1055. The network 1055 comprises a Network Management System (NMS) 1057 linked to one or more databases 1059 accessed through a PDSN 1061. The GGSN 1034 assigns Internet Protocol (IP) addresses and can also authenticate users acting as a Remote Authentication Dial-In User Service host. Firewalls located at the GGSN 1034 also perform a firewall function to restrict unauthorized traffic. Although only one GGSN 1034 is shown, it is recognized that a given SGSN 1032 may interface with one or more GGSNs 1033 to allow user data to be tunneled between the two entities as well as to and from the network 1050. When external data networks initialize sessions over the GPRS network 1050, the GGSN 1034 queries the HLR 1051 for the SGSN 1032 currently serving a MS 1041.

The BTS 1047 and BSC 1045 manage the radio interface, including controlling which Mobile Station (MS) 1041 has access to the radio channel at what time. These elements essentially relay messages between the MS 1041 and SGSN 1032. The SGSN 1032 manages communications with an MS 1041, sending and receiving data and keeping track of its location. The SGSN 1032 also registers the MS 1041, authenticates the MS 1041, and encrypts data sent to the MS 1041.

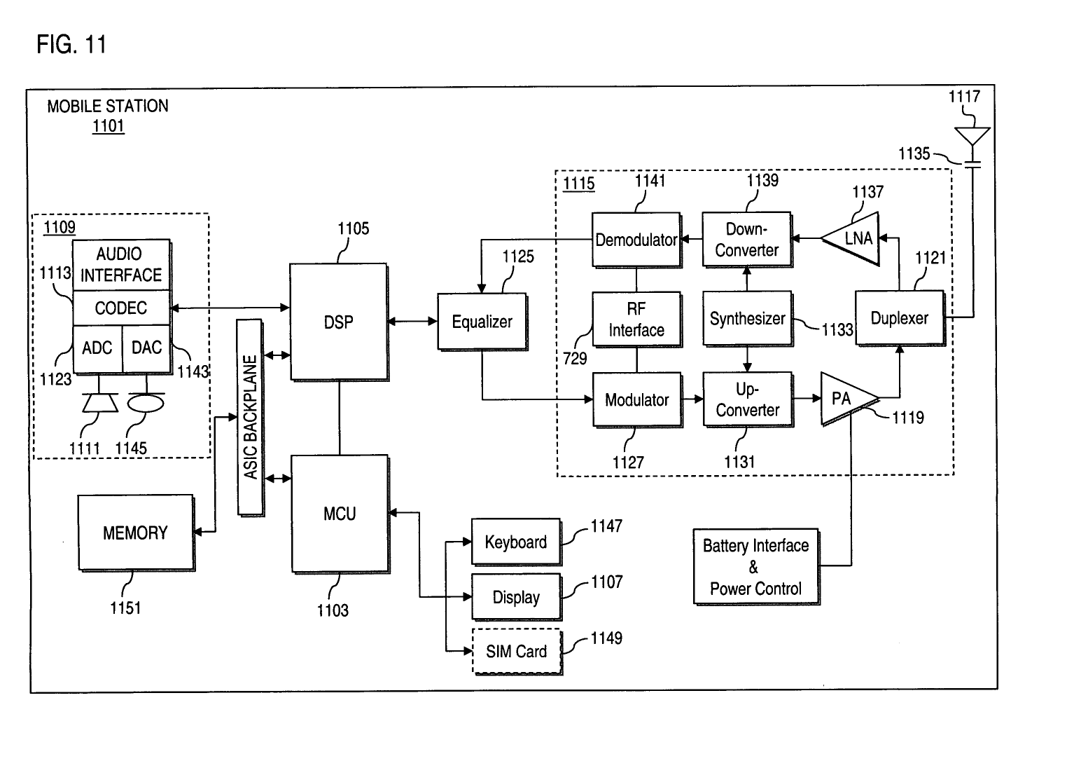

FIG. 11 is a diagram of exemplary components of a mobile station (e.g., handset) capable of operating in the systems of FIGS. 10A and 10B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system (e.g., systems of FIG. 10A or 10B), via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1005. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The MCU 1103 delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

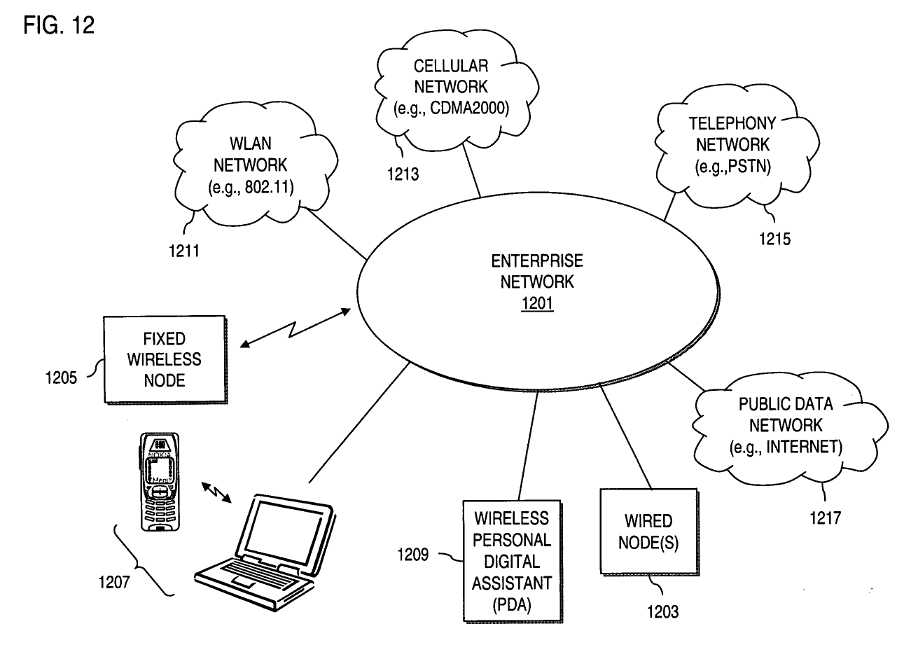

FIG. 12 shows an exemplary enterprise network, which can be any type of data communication network utilizing packet-based and/or cell-based technologies (e.g., Asynchronous Transfer Mode (ATM), Ethernet, IP-based, etc.). The enterprise network 1201 provides connectivity for wired nodes 1203 as well as wireless nodes 1205-1209 (fixed or mobile), which are each configured to perform the processes described above. The enterprise network 1201 can communicate with a variety of other networks, such as a WLAN network 1211 (e.g., IEEE 802.11), a cdma2000 cellular network 1213, a telephony network 1215 (e.g., PSTN), or a public data network 1217 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a request message from a wireless station to configure an air link of a first radio network according to a Quality of Service (QoS) requirement specified in the request message;
negotiating admission control with the wireless station in response to the received request message; and
assigning a traffic identifier for a traffic flow to be carried over the air link of the first radio network and an airlink of a second radio network based on the QoS requirement.

2. A method according to claim 1, further comprising:
generating another request message including the QoS requirement and the traffic identifier, wherein the other request message is transmitted to the second radio network according to an L3 signaling protocol, the second radio network performing admission control based on the other request message.

3. A method according to claim 1, wherein the wireless station transmits a flow mapping message to the second radio network for assisting the second radio network in determining a proper traffic identifier.

4. A method according to claim 3, further comprising:
receiving a packet from the second radio network, wherein the packet includes a tunneling header specifying the proper traffic identifier.

5. A method according to claim 1, wherein the second radio network performs admission control to accept a traffic flow from the wireless station based on a pre-determined service level agreement (SLA) corresponding to the wireless station.

6. A method according to claim 1, further comprising:
communicating with the second radio network using an inter-work QoS signaling protocol to initiate admission control by the second radio network.

7. A method according to claim 1, further comprising:
receiving a user profile corresponding to the wireless station; and
authorizing the QoS requirement according to the user profile.

8. A method according to claim 1, wherein the second radio network performs admission control to accept a traffic flow from the wireless station based on a flow mapping message from the wireless station.

9. A method according to claim 1, wherein the first radio network includes a wireless local area network (WLAN), and the second radio network includes a spread spectrum cellular system.

10. A method according to claim 9, wherein the wireless local area network operates according to an IEEE 802.11e protocol and the cellular system has a cdma2000 architecture.

11. A method according to claim 1, wherein the traffic identifier is conveyed to the second radio network for handling of the traffic flow according to the QoS requirement.

12. An apparatus comprising:
a communication interface configured to receive a request message from a wireless station to configure an air link of a first radio network according to a Quality of Service (QoS) requirement specified in the request message; and
a processor coupled to the communication interface and configured to negotiate admission control with the wireless station in response to the received request message, the processor being further configured to assign a traffic identifier for a traffic flow to be carried over the air link of the first radio network and an airlink of a second radio network based on the QoS requirement.

13. An apparatus according to claim 12, wherein the processor is further configured to generate another request message including the QoS requirement and the traffic identifier, wherein the other request message is transmitted to the second radio network according to an L3 signaling protocol, the second radio network performing admission control based on the other request message.

14. An apparatus according to claim 12, wherein the wireless station transmits a flow mapping message to the second radio network for assisting the second radio network in determining a proper traffic identifier.

15. An apparatus according to claim 14, further comprising:
another communication interface configured to receive a packet from the second radio network, wherein the packet includes a tunneling header specifying the proper traffic identifier.

16. An apparatus according to claim 12, wherein the second radio network performs admission control to accept a traffic flow from the wireless station based on a pre-determined service level agreement (SLA) corresponding to the wireless station.

17. An apparatus according to claim 12, wherein communication is established with the second radio network using an inter-work QoS signaling protocol to initiate admission control by the second radio network.

18. An apparatus according to claim 12, wherein a user profile corresponding to the wireless station is obtained, and the QoS requirement according to the user profile.

19. An apparatus according to claim 12, wherein the second radio network performs admission control to accept a traffic flow from the wireless station based on a flow mapping message from the wireless station.

20. An apparatus according to claim 12, wherein the first radio network includes a wireless local area network (WLAN), and the second radio network includes a spread spectrum cellular system.

21. An apparatus according to claim 20, wherein the wireless local area network operates according to an IEEE 802.11e protocol and the cellular system has a cdma2000 architecture.

22. An apparatus according to claim 12, wherein the traffic identifier is conveyed to the second radio network for handling of the traffic flow according to the QoS requirement.

23. A method comprising:
generating a request message for configuring an air link of a first radio network according to a Quality of Service (QoS) requirement specified in the request message, wherein the request message is transmitted to first radio network; and
communicating with the first radio network to negotiate admission control according to the request message, wherein the first radio network assigns a traffic identifier for a traffic flow to be carried over the air link of the first radio network and an airlink of a second radio network based on the QoS requirement.

24. A method according to claim 23, wherein the first radio network generates another request message including the QoS requirement and the traffic identifier for transmission to the second radio network according to an L3 signaling protocol, the second radio network performing admission control based on the other request message.

25. A method according to claim 23, further comprising:
generating a flow mapping message for transmission to the second radio network for assisting the second radio network in determining a proper traffic identifier.

26. A method according to claim 25, wherein the first radio network receives a packet from the second radio network, wherein the packet includes a tunneling header specifying the proper traffic identifier.

27. A method according to claim 23, wherein the second radio network performs admission control to accept a traffic flow based on a pre-determined service level agreement (SLA).

28. A method according to claim 23, wherein the first radio network communicates with the second radio network using an inter-work QoS signaling protocol to initiate admission control by the second radio network.

29. A method according to claim 23, wherein the first radio network obtains a user profile and authorizes the QoS requirement according to the user profile.

30. A method according to claim 23, further comprising:
generating a flow mapping message for transmission to the second radio network, wherein the second radio network performs admission control to accept a traffic flow from the based on the flow mapping message.

31. A method according to claim 23, wherein the first radio network includes a wireless local area network (WLAN), and the second radio network includes a spread spectrum cellular system.

32. A method according to claim 31, wherein the wireless local area network operates according to an IEEE 802.11e protocol and the cellular system has a cdma2000 architecture.

33. A method according to claim 23, wherein the traffic identifier is conveyed to the second radio network for handling of the traffic flow according to the QoS requirement.

34. An apparatus comprising:
a processor configured to generate a request message for configuring an air link of a first radio network according to a Quality of Service (QoS) requirement specified in the request message, wherein the request message is transmitted to first radio network; and
a communication interface coupled to the processor and configured to communicate with the first radio network to negotiate admission control according to the request message, wherein the first radio network assigns a traffic identifier for a traffic flow to be carried over the air link of the first radio network and an airlink of a second radio network based on the QoS requirement.

35. An apparatus according to claim 34, wherein the first radio network generates another request message including the QoS requirement and the traffic identifier for transmission to the second radio network according to an L3 signaling protocol, the second radio network performing admission control based on the other request message.

36. An apparatus according to claim 34, wherein the processor is further configured to generate a flow mapping message for transmission to the second radio network for assisting the second radio network in determining a proper traffic identifier.

37. An apparatus according to claim 36, wherein the first radio network receives a packet from the second radio network, wherein the packet includes a tunneling header specifying the proper traffic identifier.

38. An apparatus according to claim 34, wherein the second radio network performs admission control to accept a traffic flow based on a pre-determined service level agreement (SLA).

39. An apparatus according to claim 34, wherein the first radio network communicates with the second radio network using an inter-work QoS signaling protocol to initiate admission control by the second radio network.

40. An apparatus according to claim 34, wherein the first radio network obtains a user profile and authorizes the QoS requirement according to the user profile.

41. An apparatus according to claim 34, further comprising:
generating a flow mapping message for transmission to the second radio network, wherein the second radio network performs admission control to accept a traffic flow from the based on the flow mapping message.

42. An apparatus according to claim 34, wherein the first radio network includes a wireless local area network (WLAN), and the second radio network includes a spread spectrum cellular system.

43. An apparatus according to claim 42, wherein the wireless local area network operates according to an IEEE 802.11e protocol and the cellular system has a cdma2000 architecture.

44. An apparatus according to claim 34, wherein the traffic identifier is conveyed to the second radio network for handling of the traffic flow according to the QoS requirement.

45. A method comprising:
receiving an add stream request message from a mobile station to configure an air link of a wireless local area network, wherein the add stream request message includes a Quality of Service (QoS) parameter and a traffic identifier, the traffic identifier corresponding to a traffic flow to be carried over the air link of the wireless local area network and an airlink of a cellular network;
performing admission control and QoS authorization with the mobile station based on the QoS parameter; and
generating an add stream response message to acknowledge the received request message.

46. A method according to claim 45, further comprising:
generating a QoS request specifying the QoS parameter and the traffic identifier, wherein the QoS request message is transmitted to the cellular network according to an L3 signaling protocol, the cellular network performing admission control based on the other request message.

47. A method according to claim 45, wherein the mobile station transmits a flow mapping message to the cellular network for assisting the cellular network in determining a proper traffic identifier.

48. A method according to claim 47, further comprising:
receiving a packet from the cellular network, wherein the packet includes a tunneling header specifying the proper traffic identifier.

49. A method according to claim 45, wherein the cellular network performs admission control to accept a traffic flow from the mobile station based on a pre-determined service level agreement (SLA) corresponding to the mobile station.

50. A method according to claim 45, further comprising:
communicating with the cellular network using an inter-work QoS signaling protocol to initiate admission control by the cellular network.

51. A method according to claim 45, further comprising:
receiving a user profile corresponding to the mobile station; and
authorizing the QoS requirement according to the user profile.

52. A method according to claim 45, wherein the cellular network performs admission control to accept a traffic flow from the mobile station based on a flow mapping message from the wireless station.

53. A method according to claim 45, wherein the wireless local area network operates according to an IEEE 802.11e protocol and the cellular system has a cdma2000 architecture.

54. A method according to claim 45, wherein the QoS parameter and the traffic identifier is conveyed to the cellular network for handling of the traffic flow according to the QoS parameter.

55. A system comprising:
means for receiving an add stream request message from a mobile station to configure an air link of a wireless local area network, wherein the add stream request message includes a Quality of Service (QoS) parameter and a traffic identifier, the traffic identifier corresponding to a traffic flow to be carried over the air link of the wireless local area network and an airlink of a cellular network;
means for performing admission control and QoS authorization with the mobile station based on the QoS parameter; and
means for generating an add stream response message to acknowledge the received request message.

56. A system according to claim 55, further comprising:
means for generating a QoS request specifying the QoS parameter and the traffic identifier, wherein the QoS request message is transmitted to the cellular network according to an L3 signaling protocol, the cellular network performing admission control based on the other request message.

57. A system according to claim 55, wherein the mobile station transmits a flow mapping message to the cellular network for assisting the cellular network in determining a proper traffic identifier.

58. A system according to claim 57, further comprising:
means for receiving a packet from the cellular network, wherein the packet includes a tunneling header specifying the proper traffic identifier.

59. A system according to claim 55, wherein the cellular network performs admission control to accept a traffic flow from the mobile station based on a predetermined service level agreement (SLA) corresponding to the mobile station.

60. A system according to claim 55, further comprising:
means for communicating with the cellular network using an inter-work QoS signaling protocol to initiate admission control by the cellular network.

61. A system according to claim 55, further comprising:
means for receiving a user profile corresponding to the mobile station; and
means for authorizing the QoS requirement according to the user profile.

62. A system according to claim 55, wherein the cellular network performs admission control to accept a traffic flow from the mobile station based on a flow mapping message from the mobile station.

63. A system according to claim 55, wherein the wireless local area network operates according to an IEEE 802.11e protocol and the cellular system has a cdma2000 architecture.

64. A system according to claim 55, wherein the QoS parameter and the traffic identifier is conveyed to the cellular network for handling of the traffic flow according to the QoS parameter.
